(19) United States
(12) Patent Application Publication
(10) Pub. No.: US 2003/0212987 A1
(43) Pub. Date: Nov. 13, 2003

(54) Client container for building EJB-hosted java applications

(76) Inventors: Steven J. Demuth, Decorah, IA (US); Thomas D. Briese, Inver Grove Heights, MN (US)

Correspondence Address: DORSEY & WHITNEY LLP, INTELLECTUAL PROPERTY DEPARTMENT, 50 SOUTH SIXTH STREET, MINNEAPOLIS, MN, 55402-1498, US

(21) Appl. No.: 10/086,341

(22) Filed: Feb. 28, 2002

Related U.S. Application Data
(60) Provisional application No. 60/272,224, filed on Feb. 28, 2001.

(51) Int. Cl. G06F 9/44; G06F 9/45

(52) U.S. Cl. 717/130; 717/131; 717/154

(57) ABSTRACT

A system and method of minimizing the development cost and increasing the power of EJB-hosted Java applications is disclosed. The invention is a “client container” that extends the J2EE container paradigm to the rich client. The client container efficiently and transparently localizes certain parts of an EJB-hosted application into a client framework, where it can be easily accessed by the client application, and later re-persisted to the hosting EJB container.

### CROSS-REFERENCE TO RELATED APPLICATION(S)

This application claims priority from U.S. Provisional Patent Application No. 60/272,224, filed Feb. 28, 2001, which is hereby incorporated by reference in its entirety.

### BACKGROUND OF THE INVENTION

The present invention relates to a software “container” as an application building block. A container is a framework that establishes a coherent component and programming model for some subset of the distributed programming problem space, and provides a standardized set of services to facilitate construction of software within that problem space. Specifically, the container is implemented on the client of a multi-tier processing environment. A be programmer following certain programming models and using the “client container” can rapidly and economically develop high-performance Java applications with a rich graphical user interface.

Whereas an application using HTML in a browser might be sufficient for an individual browsing and buying one book at a time, the client container could be used to economically construct highly sophisticated applications to manage the acquisition, purchase, and management of an entire inventory of books. Whereas an HTML application requires a performance-degrading query to a server any time data needs to be validated or new data is required, the client container can encapsulate complex business logic and data to make such frequent validation unnecessary. Compared to a Java application constructed by hand, the client container manages many kinds of difficult to implement services, and eliminates the performance degradation associated with management of state locality for persistent objects, decoupling of state and behavior, and other limitations in the typical remote method invocation or object by value approaches taken to Java application development.

Economical and effective software development makes great use of application building blocks. The Java programming language and Java deployment specifications from Sun Microsystems provide an important and broadly-used set of application building blocks.

The Java 2 Platform, Enterprise Edition (J2EE) specification provides a foundation for building server-based enterprise-class software applications. One part of the J2EE specification, the Enterprise JavaBeans (EJB) component architecture, is designed to enable enterprises to build scalable, secure, multi-platform, business-critical applications as reusable, server-side components. The EJB specification creates an infrastructure that takes care of the system-level programming, such as transactions, security, threading, naming, object life cycle, resource pooling, remote access, and persistence. It also simplifies access to existing applications, and provides a uniform application development model for tool creation and use.

The Java 2 Platform, Standard Edition (J2SE) specification, among other things, provides the Swing Java Foundation Classes (Swing) that are a graphical user interface component kit allowing for development of rich graphical user interface (GUI) applications. Swing simplifies development of applications by providing a complete set of user-interface elements written entirely in the Java programming language. Swing components permit a customizable look and feel without relying on any specific windowing system.

Though the J2EE specifications define server-based resources for managing data and behavior, and Swing and the Java Virtual Machine (JVM) provides client-based resources for GUI construction, the combined specifications do not provide sufficient resources for integration between an EJB server and a Swing client. A Java Virtual Machine acts as an interpreter between the Java bytecode and a computer's operating system. There are JVMs for a wide range of computer platforms, such as Macintosh, Windows, and Unix.

The EJB specification provides ample methods for rendering HTML-based web applications; for example, servlets to transmit static HTMl, or Java Server Pages to generate dynamic HTML content with a web server or application server. This reflects the central role HTML-based applications have had in the evolution of Java-based application servers in general, and EJB in particular, and in part the relative immaturity of Java as a GUI platform until recently.

Despite the lack of inherent support for easy development of GUI applications in J2EE, such applications offer many advantages over HTML by* applications. First, a well designed GUI presents a rich, responsive, flexible and explorable interface to the user. Second, GUIs built to use EJB hosted application logic have additional advantages over other GUI approaches. First and foremost, placing the business logic in an EJB container permits the GUI application to avail itself of all the standard services provided by an EJB-compliant application server. Second, as enterprises invest in writing application logic using EJB for web applications, there are increasing needs for dual presentation of the same logic: one for public use via HTML, and one optimized or extended for enterprise use using the GUI paradigm.

Despite the advantages of GUI applications, however, there remain significant obstacles to simple, standardized construction of such software. In order to write a successful, rich GUT application using remotely hosted application logic, a developer has to manage a number of complex issues. The issues include state locality for persistent objects, decoupling of state and behavior, getting appropriate objects, delta tracking, resolution, and coupling interface components to data. These issues are now discussed in turn.

State locality for persistent objects: By definition, an EJB resides on the server. Thus, remote application developers must typically explicitly manage movement of the state of an entity bean from the server to the client, and vice versa. By far the simplest way to do this is to leave the state on the server, and use remote interfaces to get and set values, or request other operations, whenever required. This amounts to programming the distributed application as if it were in fact a monolithic application. While simple, this does not scale to non-trivial applications. The latency in remote method invocations, and the frequent need for those applications in even a minimally data rich application, quickly make the application perform very poorly. Furthermore, if Java Swing controls and their associated model interfaces are used to construct the GUI, even the simplest application is likely to perform abysmally because of the high frequency and redundancy (from the point of view of the application logic, if not from that of the presentation logic) with which those controls get and set information.

As an alternative, developers often use “value objects” to transport the entire state of an entity or collection of entities to the client, where it can be directly manipulated. At some later time at the user's request, the value objects are resolved back to the server, including any changes. Although this approach can eliminate the performance bottlenecks, it introduces a host of new issues for the developer to manage.

Decoupling of state and behavior: Close coupling of state with behavior through class definitions is one of the primary reasons for the success of the object oriented programming paradigm. But when using value objects for remote development, this coupling is broken. If the server side programmer has placed constraint logic in their EJBs, for example, this will be unavailable to the GUI. Either the GUI has to duplicate the required constraints (putting the same logic in two code bases), or constraint validation must be deferred until the objects are re-persisted to the server (depriving the user of useful, real-time feedback).

Getting appropriate objects: In a GUI application, the user often determines what data they wish to manipulate independently of pre-defined work flows. That is, the user may choose to explore and manipulate one branch of a collection of objects that represent a transaction in one unit of work, and a completely different branch the next time. Furthermore, they may get to the same objects via different navigation routes to the same information. This presents serious management issues for the developer, who must anticipate what data is likely to be needed, detect it's absence if it has not yet been retrieved and graft any newly retrieved data to that already in the GUI, without affecting changes already made by the user. In a typical application, a great deal of code that is explicitly dependent on the structure of the data and on the server side implementation can be required.

Delta tracking: In many applications, a user typically views an order of magnitude more information than they eventually change. Because of the cost of re-persisting unchanged information back to the server, a programmer is often required to track changes to data on an object by object basis, and provide logic to save only those elements that have changed. In the simplest interfaces, this is trivial, but in more complex situations, it can easily become a large task. Logic may be required to identify changes, deletions and insertions, and to distinguish between empty and non-existent collections, for example. In addition, it is often not sufficient to know that a group of objects have changed, but also the order in which they were changed. This is a complex problem for the programmer.

Resolution: A GUI application must implement some method for a user to save the information they have changed. In the simplest, naive case using value objects, the programmer simply identifies each changed object and tells the server to update the persistent state of the application to reflect the change. Modified objects are updated, deleted objects removed, and created objects inserted. In reality, however, things may not be so simple, because the order in which changes occur can be highly significant, particularly when the remote objects on the server contain specialized business logic associated with state changes. Typically a developer has to write specialized resolution logic for a variety of change scenarios, and in many cases, to limit the flexibility of the user interface in order to limit the number of change scenarios to be managed.

Coupling Interface Components to Data: In the Java world of Swing components, a significant programming effort can be required to get data from the value objects on the client, or remote objects on the server, into GUI controls. In the Swing Model-View-Controller (MVC) programming model, every component has its own model interface. If the developer wants to use MVC fully, every control may require a separate, custom model implementation. This is because, typically, views are displaying disparate data; different textboxes display different fields, etc. Only rarely do separate view components benefit from sharing a model instance. Alternatively, the developer may choose to explicitly manage movement of data from the value objects to the GUI controls, thus losing the advantage of the Swing MVC architecture.

Although this is in many ways the least onerous of the burdens discussed here, because model implementations are typically fairly simple “cookie cutter” code, in an application with dozens of screens, each with a large number of GUI controls, the code can be quite burdensome.

There is a need in the art for a framework for effective and economical development of rich GUI Java applications that takes advantage of EJB hosted application logic. More specifically, there is a need for easy yet powerful development of Java applications in J2EE.

### BRIEF SUMMARY OF THE INVENTION

The present invention embodies a system and method of minimizing the development cost and increasing the power of EJB-hosted Java applications. The solution is a “client container” that extends the J2EE container paradigm to the rich client. The client container efficiently and transparently localizes certain parts of an EJB hosted application into a client framework, where it can be easily accessed by the client application, and later re-persisted to the hosting EJB container.

The client container is a framework that requires a developer to follow certain programming models, and in return provides standardized services to simplify a wide class of common development requirements. It is a container in the literal sense of “containing” or “hosting” specified portions of the client application.

The client container includes a programming model whereby lightweight object models are created as a subset of the main domain object model constructed as EJBs on the server. The client container provides lifecycle management of these lightweight objects by providing services for object graph transport and extension, lightweight object behavior management, delta tracking and resolution through function shipping and dynamic proxies, and checkpoints and rollback. The lightweight object model, modified by the user, is then resolved back into heavyweight object model on the server. This method of managing business logic between the server and the client allows users to have a rich GUI with appropriate levels of interactivity with the domain model, while retaining functions that appropriately belong on the server and not on the client.

The client container presents characteristics that are advantageous to users. First, the client container allows creation of user interfaces substantially richer than HTML applications. The container supports user visualization and manipulation of data using standard graphical techniques (such as drag and drop). It provides an active view of screen images to represent concepts and entities that are themselves directly accessible to manipulation.

Second, compared to both HTML and non-client container Java applications, the application is substantially more responsive. HTML applications require round-trip access to the server and a complete page redraw in order to make minor changes to a transaction. Even under the best of circumstances, this typically requires enough time to introduce a pause in the user's interaction with the application. Users expect better from a real application. In interaction intensive situations, the difference can have significant impact on productivity. Compared to Java applications built without the client container, the management of the interactions between Swing components and the EJB container create all of the performance issues associated with remote method invocation on a component-by-component basis, or the programming and maintenance complexity associated with using object by value.

Third, the application is more flexible and explorable compared to an HTML interface. Different users manipulate a typical GUI application differently. For example, some traverse a screen using the mouse, others with the keyboard (using shortcuts and tabs). In many instances, users may want to explore multiple views of a single related collection of information. They may wish to switch back and forth dynamically between a tabular and graphical portrayal of the same data set for example.

The client container also provides developers with a more rapid and efficient method for developing applications. All of the infrastructure programming tasks associated with managing state locality for persistent objects, decoupling of state and behavior, object access and so on, are managed by the container and do not require hand-coding.

In addition, client-aware components allow programmers to implement applications in a rapid application development (RAD) programming mode. These kinds of interface components are familiar to programmers familiar with integrated development environments (IDEs) like Visual Basic, a product of Microsoft Corporation of Redmond, WA, or Delphi, a product of Borland Corporation of Scott's Valley, CA. IDEs are used by programmers because they speed the creation of visual and non-visual program components, allowing software products to be completed more rapidly and economically. The client container-aware Swing components are provided in such a fashion that they can be imported into a Java IDE like JBuilder, a product of Borland Corporation, Visual Age for Java, a product of IBM Corporation of Armonk, N.Y., or WebGain, a product of WebGain Corporation of Santa Clara, Calif.

As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram that depicts the Java 2 Platform, Enterprise Edition (J2EE) Application Model;

FIG. 2 is a block diagram illustrating common practice for implementing server-based logic and presentation and client-side presentation rendered as HTML in a browser;

FIG. 3 is a flowchart illustrating queries and responses in an EJB server and HTML/browser client;

FIG. 4 is a block diagram illustrating common practice for implementing a Java application client accessing business logic from an EJB server using remote interfaces and value objects;

FIG. 5 is a block diagram depicting a client container for implementing rich client GUIs in Java;

FIGS. 6A-6C are examples of a typical domain object graph and examples of Java programming language implementations for object graph transport and extension;

FIG. 7 is a Unified Modeling Language (UML) model demonstrating implementation of lightweight behavior in the client container;

FIG. 8 is a flowchart illustrating implementation of checkpoints and rollbacks in management of object graphs in the client container;

FIG. 9 is a block diagram depicting client container aware controls using the Swing Java Foundation Classes.

FIGS. 10A and 10B are block diagrams illustrating a process for resolving changes occurring on the client back to the EJB server.

FIG. 11 is a block diagram illustrating the transformation of a heavyweight entity bean graph into a lightweight object graph.

### DETAILED DESCRIPTION

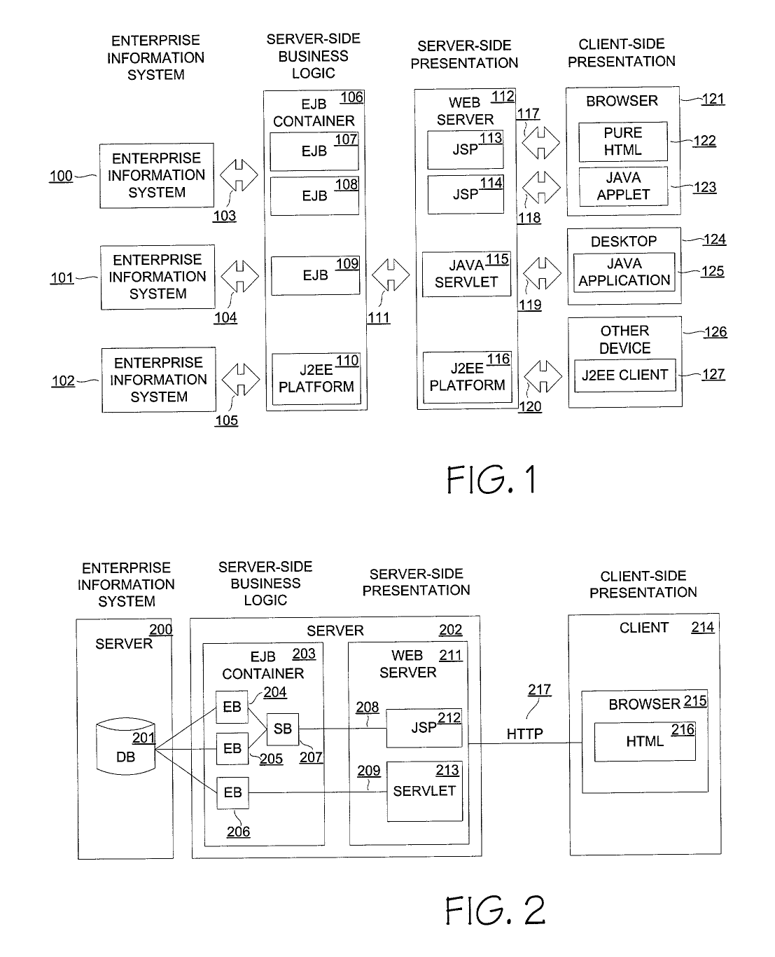

With reference now to the figures, FIG. 1 depicts the Java 2 Platform, Enterprise Edition (J2EE) application model, a product of Sun Microsystems, Inc. in Palo Alto, Calif. This diagram is used by Sun Microsystems to depict the various means that Sun Microsystems recommends for developing new applications and integrating new ones using Java technologies. It is possible, though not typical, that each of these technologies would be deployed within a single enterprise.

Enterprise Information Systems 100, 101, 102, might be existing applications or databases. They are accessed across some application or hardware boundary by software running within an Enterprise JavaBeans (EJB) Container 106. EJB Container 106 provides server side business logic, as well as shared services such as support for transactions, security, threading, naming, object lifecycle, resource pooling, remote access and persistence. Depending on the design of a particular application, there may be multiple EJBs 107, 108 and 109 that encapsulate business logic and map to various enterprise information system resources.

There are multiple methods by which enterprise information systems can be accessed by J2EE-based software. For example, Enterprise Information System 100 could be accessed by some type of Enterprise Application Integration Bridge 103. Enterprise Information System 101 might be a database, in which case it could be accessed by database access technology like Java Database Connectivity (JDBC) 104. Or, the J2EE-compliant EJB container could access Enterprise Information System using Java-based integration such as Java Connector Architecture 105.

Web Server 112 provides server-side presentation, which is defined as the generation of resources to be consumed by client-side presentation services, as well as management of interaction with the client. Web Server 112 may contain Java Server Pages (JSP) 113, 114 that can generate Hypertext Markup Language (HTML) text files that are typically transported via Hypertext Transfer Protocol (HTTP) 117 where the pure HTML presentation 122 is rendered by a Browser 121 on a client machine. The Browser 121 is responsible for rendering the HTML so that a user can interact with it.

Alternatively, JSP 113, 114 may generate any arbitrary text data that is transported via HTTP 118 to Java Applet 123. Java Applet 123 is Java bytecode downloaded to a client and rendered within a browser using some form of Java Virtual Machine (JVM) plug-in technology included in the browser. After Java Applet 123 is operating within the browser, the applet can consume text based or binary data transported over an appropriate protocol.

Alternatively, Desktop Client Computer 124 may have Executable Java Application 125 installed. Java Application 125 interacts with Java Servlet 115 on the web browser using HTTP 119. Alternatively, the Java application can interact directly with the EJBs using Remote Method Invocation (RMI) over Internet Inter-ORB Protocol (IIOP), specifically with a compiled element of the EJB known as an IIOP skeleton. RMI is standard programming technique implemented in slightly different fashions depending on the programming platform; IIOP is part of the Common Object Request Broker (CORBA) specification from the Object Management Group of Needham, Mass., a non-proprietary standard for interaction between object-oriented computing platforms. Despite the CORBA standard for interoperability between Java Application 125 and Java Servlet 115, a substantial amount of custom coding is required to manage interactions between the two.

Finally, the J2EE specification supports interaction between J2EE resource for Server-Side Business Logic 110, Server-Side Presentation 116 and some Other Device 126 that supports a J2EE Client 127 running in a Java Virtual Machine. The other kind of device could be an automatic teller machine, some kind of equipment requiring real-time processing, and so on.

FIG. 2 is a block diagram showing the typical method used to implement an HTML client using J2EE-based server technologies. Server 200 hosts Database 201. Server 202 hosts two components: EJB Container 203, which contains business logic and data access in the form of EJBs, and Web Server 211, which manages server-side presentation to the client. Client Computer 214 hosts Browser 215, which presents pages composed of HTML Text 216.

Within EJB Container 203, there are two main types of EJBs. One kind of EJB is Session Bean 207. These contain various kinds of application logic and manage the application process at the level of granularity such as “open client record,” “update client record,” or “save client record”. Session Bean 207 interfaces are defined and developed by programmers. Typically, an application consists of multiple session beans. A second kind of EJBs are Entity Beans 204, 205 and 206 that are data objects responsible for accessing data and presenting a view of the data.

There are a variety of different methods for creating and managing EJBs, and the state of the art in Java programming continues to change. The general differentiation is between methods that use EJBs to manage business logic and data, and methods that use EJBs solely for state management and encapsulate business logic in some other location, such as a servlet layer.

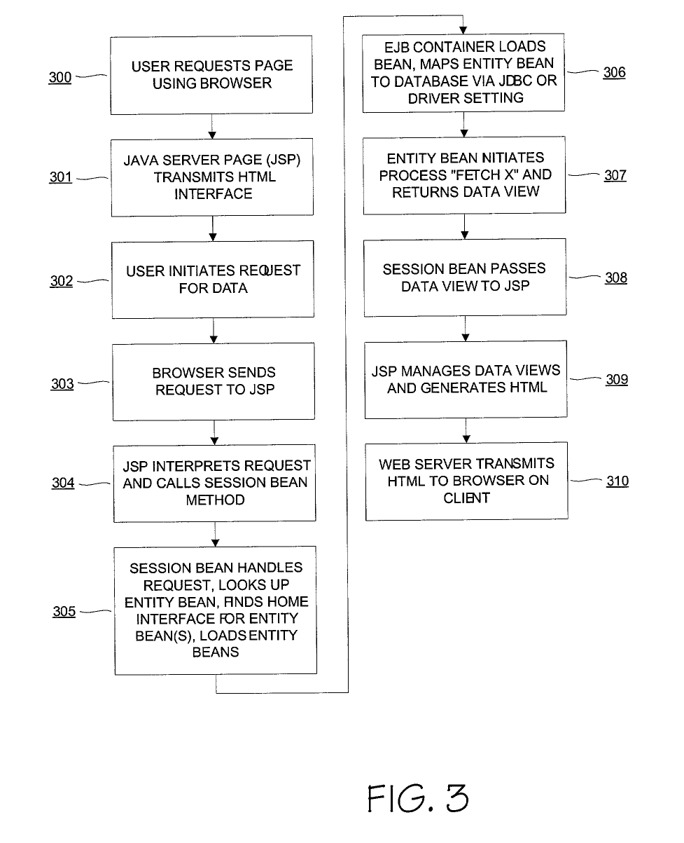

FIG. 3 is a flowchart that shows the steps by which a client accesses data and business logic using a combination of entity beans and session beans. The process begins when a user requests a page using a Browser 300. The JSP might, as a first step, generate an HTML page that contains only static data, without accessing the rest of the application 301. A user initiates a request for data, commonly by selecting a hyperlink on an HTML page 302. The browser sends the request to the JSP 303. The JSP interprets the request, and calls a session bean method, such as “open record”, that may require the use of one or more session beans in the EJB container 304. In response to instructions from the EJB container 304, the session beans locate the home interface for the entity beans 305 in which data access methods are described, then uses the home interface to “look up” the specific entity beans instances representing required data.

The EJB container is responsible for managing all the housekeeping associated with bean creation and management. The EJB container loads the appropriate entity beans, maps the entity beans to the database via some method like Java Database Connectivity (JDBC) or a driver provided by the database for access by Java entity beans or EJB containers 306. The entity bean initiates a process such as “fetch data X” and returns a data view that contains the current state of the requested data 307. The session bean passes this data view to the JSP 308. The JSP manages one or more data views and generates HTML with text values representing the current state of the data 309. The web server transmits HTML via HTTP to the browser on the client 310.

Programmers familiar with distributed programming, in which methods are invoked on separate physical machines, will recognize this general method and understand how the J2EE programming specification is similar to other methods for distributed computing and remote method invocation. They will also recognize the limitations imposed by this model on application performance and sophistication of presentation and interaction between application layers.

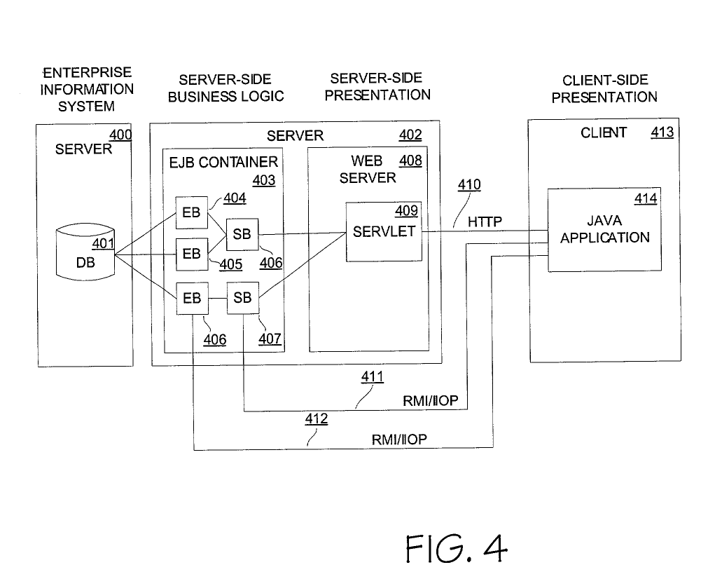

FIG. 4 is a block diagram showing some variations of distributed computing architectures using an installed Java application on the client computer. Server 400 hosts Database 401. Server 402 hosts EJB Container 403 and Web Server 408. Client 413 has Java Application 414 installed as an executable program. Java Application 414 can connect to server logic and data in one of three ways. In the first approach Java Application 414 can connect via HTTP 410 to Servlet 409 that can either call session bean methods from the Session Bean 406 and 407, or connect directly to entity beans 404 and 405 and manage state within Servlet 409. In FIG. 4, only connection to the session bean layer is shown, for clarity.

In the second approach Java Application 414 can connect to the server via RMI over IIOP 411, directly invoking Session Bean 407 and session bean methods in EJB container 403. In this approach, Java Application 414 explicitly manages the state of an entity bean from the server to the client, and vice versa. In the third approach, the Java Application 414 can connect to the server via RMI over IIOP 412, using “value objects” to transport the entire state of an entity or collection of entities to Java Application 414, where it can be directly manipulated.

Regardless of the programming approach taken, Java Application 414 needs to directly or indirectly create and manipulate an object graph on the server any time the state of the data changes, or it needs to transport large object graphs to the client and manage state manually. These are complex approaches with all of the difficulties described in the Background of the Invention.

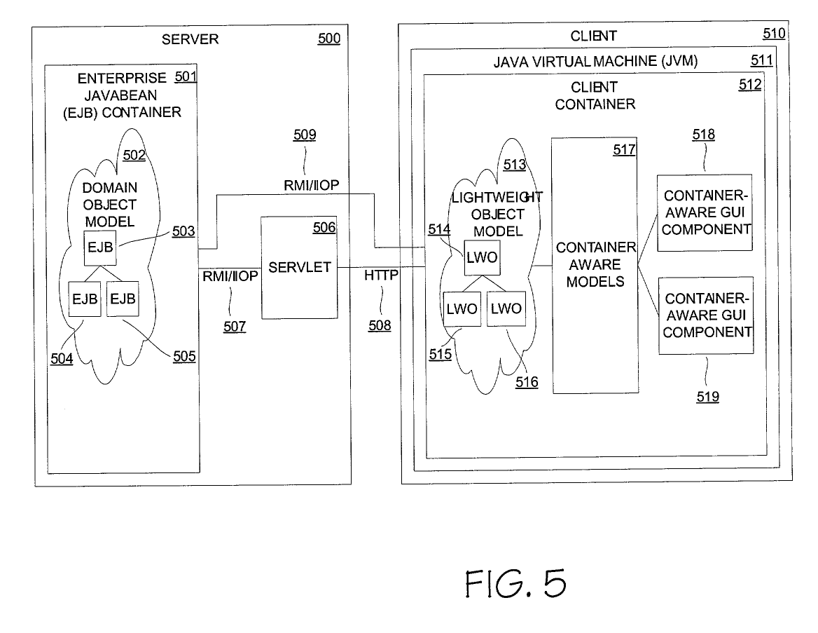

FIG. 5 is a block diagram showing how a client container would interact with an EJB container in a distributed computing environment. Server 500 hosts EJB Container 501. A software application is composed, in part, of Domain Object Model 502 that is made up of multiple EJBs 503, 504 and 505, in an object graph. On Client Computer 510 the Client Container 512 operates within Java Virtual Machine (JVM) 511. Client Container 512 can connect directly to EJB Container 501 via RMI over IIOP 509, or via Servlet 506 on Server 500. Servlet 506 would communicate with EJB Container 501 using RMI over IIOP 507, but would communicate with Client Container 512 via HTTP 508. Such a protocol is appropriate, for example, where firewalls admit only HTTP traffic.

The client container hosts three main components. The first component is Lightweight Object (LWO) Model 513. LWO Model 513 is composed of some subset of main Domain Object Model 502 on Server 500. Client Container 512 provides lifecycle management of Lightweight Objects 514, 515, and 516 by providing services for object graph transport and extension, lightweight object behavior management, delta tracking and resolution through function shipping and dynamic proxies, and checkpoints and rollback. Each of these services are described in detail in the following figures and accompanying text.

The second component is Container Aware Models 517. A model is one part of a model-view-controller architecture. The Swing model-view-controller (MVC) architecture is fairly straightforward. In traditional MVC, the model is the actual data to be presented by a view component, or modified by a controller component. In Swing, as in most MVC architectures, the view and controller are typically the same component (class) and models are defined in terms of model interfaces for each class of component. In a typical Swing GUI, there is one model implementation for each component in the application. These model implementations perform the translation from the actual domain object data representation, into the appropriate model interface. The client container is ideally situated to eliminate the need for most custom model implementation. It contains and controls access to the domain object model, and can present it in whatever format (model interface) required for a component.

Container Aware Model 517 extends Swing models to provide the functionality necessary to allow GUI components to interact with the actual lightweight objects. This functionality includes:

Container aware models are designed to be listeners to a ModelSource, and receive events appropriately from the ModelSource. This occurs because container aware models implement a generic model listening interface.

Additional properties are added to allow models to be aware of and interact with ModelSource components for purposes of registering themselves as listeners to a ModelSource.

Additional properties are added to allow a container aware GUI component to alert its corresponding model when the field name the control is bound to changes (meaning the model must also change what field it interacts with).

Container aware models are able to traverse a lightweight graph and interact with the specific property the model is bound to. This includes reflective capabilities.

Error handling capabilities have been added to a container aware model, allowing it to surface an error to a listening error handler, or propogate the error higher up a chain.

Provision of a rich client GUI requires the ability for a user to interact with the application domain in a meaningful way. This requires that some subset of business logic and presentation needs to be located within the client container. The method by which object state on the client and server are synchronized, using heavyweight and lightweight behavior and state consistency, is described in the subsequent section.

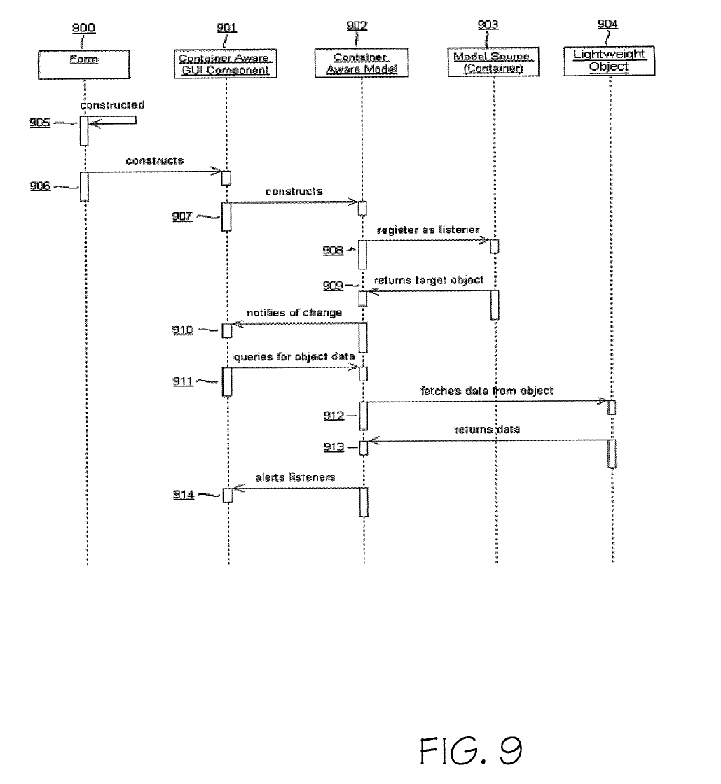

Container-Aware GUI Components 518, 519 are Java components adapted for use with the Container Aware Model 517 to interact with the Lightweight Objects 514, 515, 516 of the Lightweight Object Model 513. These components and their interactions are further described below with reference to FIG. 9.

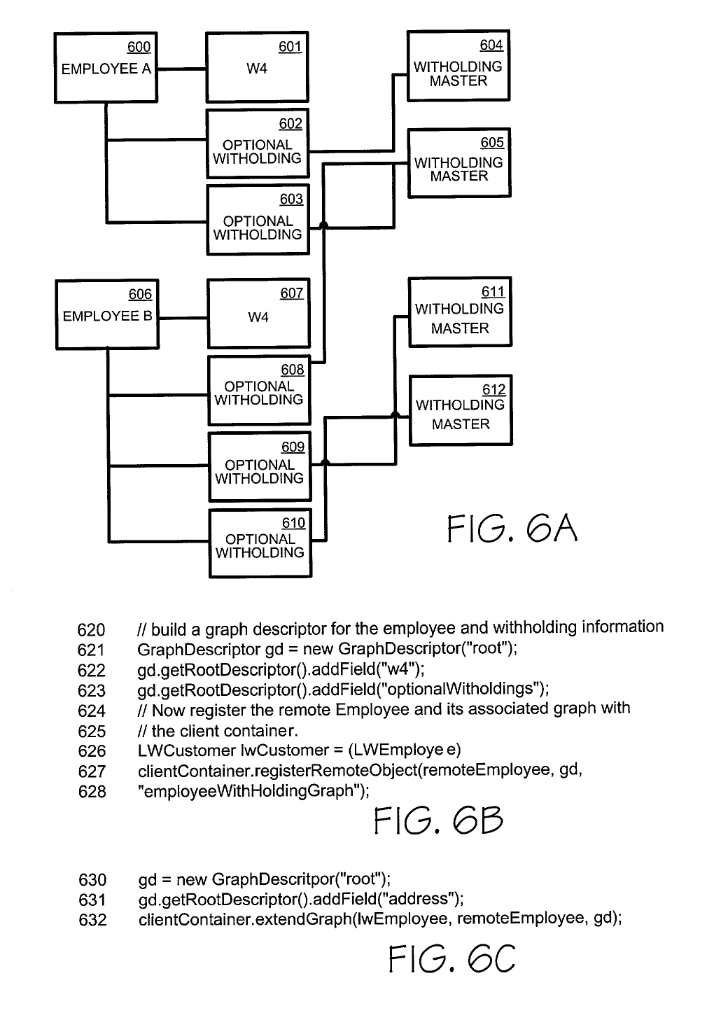

With reference now to FIG. 6A, a sample domain object graph, modeling of a simple employee information system is shown. In the most common object oriented analysis and design methodologies in use today, the details of user interactions are captured in design documents called “use cases.” A typical use case describes a single unit of work, from the user's perspective, such as, “enter an order,” or “change an employee's withholding information.” More complex interactions are built up from combinations of simpler interactions. Thus a “create a new employee” use case would consist of multiple simpler use cases, including “change an employee's withholding information.” Some designer's document use cases with Unified Markup Language (UML) diagrams, others prefer simple narrative or tabular documents.

The actual content and structure of an application domain is described in terms of a domain object model. A domain object model is familiar to any object oriented developer: a banking application has “Account” and “AccountHolder” and “Transaction” domain classes, for example. The relationships between these domain classes, (such as AccountHolder “owns” an Account,) define the structure of the problem domain, and their contents define the data domain for the application. Including all the actual object instances of the classes in the domain object model, and all their relationships, creates a giant web or graph, with objects (Employees, Accounts, etc.) as the nodes, and navigable relations as the edges. This map of domain objects and graphs is referred to as a “domain object graph.”

As an example, consider a typical “primitive” use case—that is, one that is not built up from other use cases—together with the entire domain object model. It is possible to fairly quickly identify a subset of the domain model that is of interest to that use case. In the employee example, for example, “change an employee's withholding information” might require “Employee A” Class 600, associated W4 Class 601 and OptionalWitholding Classes 602, 603. These three classes would represent only a small fraction of all the classes in a complete Human Resources system, but would contain all the information and behavior required for the “create a new employee” use case. That is, this is a simple mapping from the use case to a subset of the domain object model.

In the case of a particular invocation of the use case—one user changing the withholding for one employee—it is possible to identify a subset of the domain object graph that encompasses all the objects needed to execute this use case. The subset of the domain object graph is a complete, extensive web of real objects that contains all the data for the Human Resources system. The subset is created by finding the particular Employee A 600 required, and then traversing the domain object graph to get the W4 601 and all the OptionalWithholding 602, 603 for Employee A 600. The resulting subset of the domain object graph is rooted at Employee A 600 in the sense that you can get to any element of it by starting at the Employee A 600 object and navigating to the other objects. Mapping from a use case invocation to a subset of the domain model is referred to as a “named subgraph” of the domain.

Referring to FIG. 5, Client Container 512 contains a number of services. The first service provided by Client Container 512 is an “object provider.” The object provider efficiently localizes subsets of the entire domain onto the client for manipulation. In order to do this, some method is required for identifying what subset of the entire domain object graph is needed.

The notion of “named object graphs” is helpful here. The basic approach is to identify a root object, say Employee B 606 FIG. 6A, and then to use a “graph descriptor” to specify a degree of traversal for the graph from this node. In the example, this would mean a graph descriptor that declares, “from the root node Employee B 606, also get me W4 607 and OptionalWithholding 608, 609, 610.”

In the implementation of the client container, an example of the code is shown in FIG. 6B. The arguments on the registerRemoteObject call 620 are: a remote interface to the root object of the graph, in this case, an Employee; the built-up graph descriptor, and a name by which the graph can be referenced once instantiated into the container.

Those of ordinary skill in the art will understand that this is quite flexible. If, for example, the application requires access to information from Withholding Master 611, 612 objects that contained minimum and maximum values for specific withholding type, they could be included in the graph by changing the last line of code to:

gd.getRootDescriptor( ).addField(“optionalWitholdings”).

addField(“withholding”).

The mechanism for doing the actual transport is a straightforward extension of Java serialization. Initially, the server is asked to serialize a particular root entity represented by an entity bean in the EJB container, along with everything identified by the graph descriptor reachable from the root.

A serialized EJB, however, should not be recreated on the client. A serialized entity EJB would introduce undesirable complexity, including references to Javax.ejb.Entity, its entity context, and potentially other JDBC related classes used for bean managed persistence. This is avoided by returning a serialized version of a “lightweight entity” whenever an entity bean is encountered in the graph. Lightweight objects are described in detail in the next section.

The serialization mechanism has to know when to stop. For example, if OptionalWitholding 602, 603 objects in the optionalWithholding collection have references to their Withholding Master 604, 605 objects, but they are not needed for the user interaction required, the serialization of the OptionalWithholding objects returns a condition for this field that indicates the object was not retrieved.

The utility of this mechanism depends to a large extent on the postulated mapping between use cases, user interaction scenarios, and particular object subgraphs. The objective is to optimize the user experience by transporting a minimal sub-graph containing only objects known to be nearly always required, then later extend this with additional information when the user wants to explore more deeply. For example, Master Withholding 604, 605 objects are not wanted for most interactions, but the application still needs to permit the user to examine and modify them under certain circumstances.

To facilitate additional information, the client container supports “graph extension.” Given an existing object graph, the client container can add additional nodes to the graph wherever the original retrieval from the domain left references to “not retrieved” objects. FIG. 6C shows an example of code to implement “graph extension.” Here the arguments to extendGraph are: the Employee object already in the container 630, the remote interface to the server implementation of that object 631, and the graph descriptor.

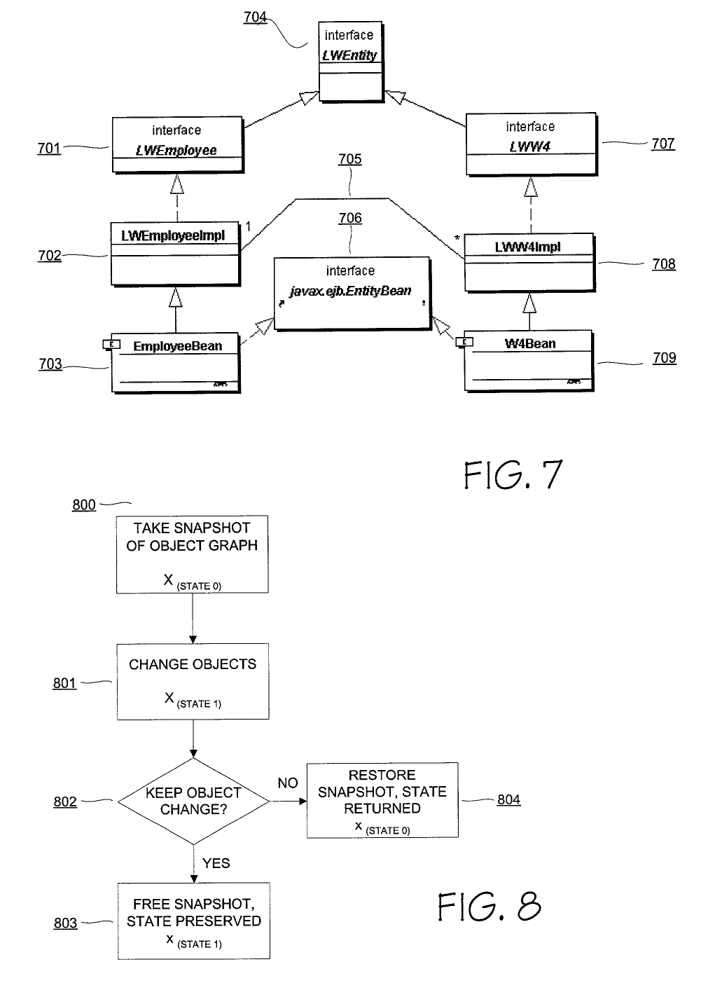

To assist the removal of a subset of the domain object graph, a programming technique or model is used when creating the domain object model. A Unified Markup Language (UML) diagram of an object model is shown in FIG. 7. The object model includes “lightweight object behavior” that allows the application to transport a copy of the necessary application logic and data to the client for manipulation, while maintaining transactional logic on the server.

One of the difficult problems of building distributed applications is locating business behavior in the appropriate application tier. Much business logic is explicitly transactional and belongs on the server tier. The EJB container mode works nicely for this. Other behavior, however, is more useful on both the server and the client. Placing this behavior on both the server and client, however, requires careful coordination of the behavior.

The client container handles this behavior by extending the concept of value objects to include lightweight behavior. Lightweight behavior is behavior that is appropriate to execute in a non-transactional environment, such as a client executing on a remote machine.

To establish lightweight behavior, the domain object is split into two components: a lightweight version, and its associated heavyweight. FIG. 7 shows examples of the relationship between lightweight and heavyweight objects. A standard entity EJB 703 or 709 representing the heavyweight implementation inherits from the lightweight version of the same domain concept 702 or 708, respectively. This lightweight implementation object in turn implements a lightweight domain interface 701 or 707, respectively, that inherits from a standard lightweight entity interface. The common lightweight entity interface is required for other features of the client container described below.

Referring to FIG. 7, LWEmployee 701, LWEmployeeImpl 702, Employee Bean 703, and LWEntity 704 provide one example of a model where the heavyweight object inherits the lightweight objects. LWW4 707, LWW4Impl 708, W4Bean 709, and LWEntity provide another example of a model where the heavyweight object inherits from the lightweight objects.

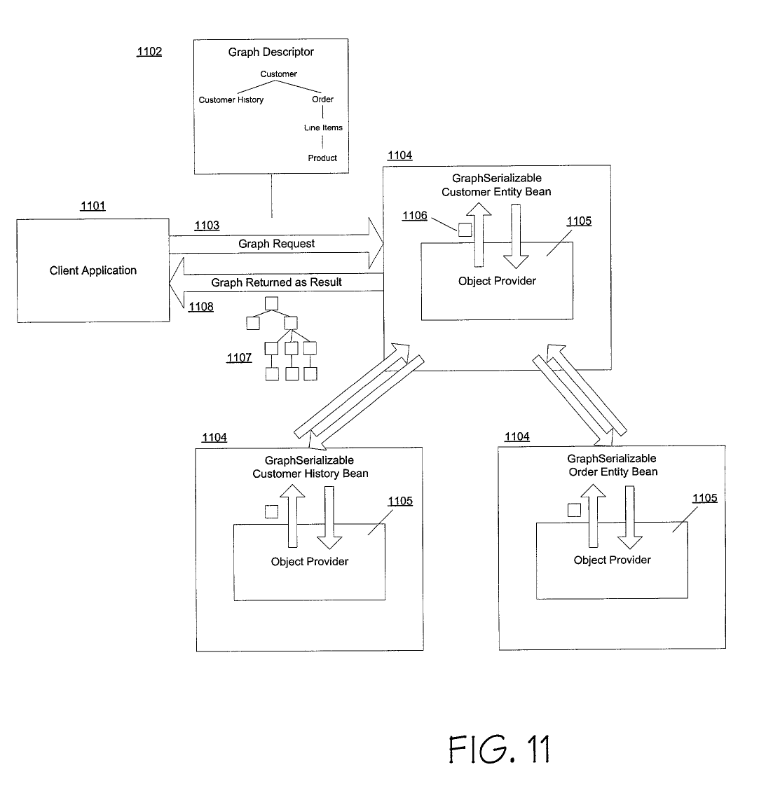

In the W4 example from FIG. 7, the logic that is required both on the client and on the server, such as constraints on field values, is placed in LWW4Impl 708 object, but behavior that is specific to the server, such as persistence, or optimistic concurrency, or constraints that must be checked against dynamic values, is placed in the W4Bean 709, the heavyweight object. The entity bean implements javax.ejb.EntityBean 706, which is a standard interface that EJBs implement; it is the contract the bean class (703 or 709, for example) agrees to for using services the container provides. The process of generating a lightweight object graph and transporting it to the client is further described with reference to FIG. 11.

The next service provided by the client container is delta tracking and resolution through function shipping and dynamic proxies. One of the more onerous tasks in writing a remote client is keeping track of changed objects, and resolving them back to the server. In applications with fixed or very simple work flows or with no business logic at all on the client (both requirements easily met by HTML applications), the typical approach is simple: users are allowed to modify some objects and a message is sent to the server to modify the state of a data object to match the new state defined by the user.

But in applications that have flexible navigation and workflow for a given user interaction, and those with some degree of business logic on the client, things can be substantially more complex. A user may modify some objects, add and delete an arbitrary number of others, and change the relationships of yet others, all within what the user sees as a single task. Furthermore, the order of interactions can in some cases be significant. Somehow the client and server code have to cooperate to persist these changes back into the server environment.

The client's major interest in this process is to make sure enough information is returned to the server, but not too much. If a user examines 500 objects in the course of a task, but changes only 3, only those 3 are sent back to the server for synchronization.

One approach to resolving this borrows from an established engineering practice in database replication and synchronization. Many replication products use a design known as “function shipping” to synchronize multiple copies of data. In function shipping, the correspondent database records a log of all change operations and ships that to the remote database for replay against the remote copy.

The client container implements this approach: once an object graph is instantiated into the container, the container tracks all changes made to the objects by keeping a log of the method invocations that accomplish these changes. This is, in general, a rather substantial task. It is made substantially simpler by the addition of dynamic proxies to the Java language as of Java development kit (jdk) 1.3.

In order to understand how dynamic proxies help, consider the nature of the objects in the client container. The object model that details the relationship between lightweight implementations and entity beans shows that all the lightweight implementation classes implement an interface (LWxxxx) that encapsulates their business semantics, and that the LWxxxx in turn extend a standard interface, LWEntity 704.

The LWxxxx interfaces are important because they define all permitted interactions with a given lightweight class, and using dynamic proxies to construct on the fly an “interceptor” class that captures all interactions between the client code and the lightweight object.

As an example, suppose a graph consists only of a specified Employee object. To instantiate this into the client container so that it is possible to track changes to it, the following takes place:

The client code identifies the required entity bean (EmployeeBean with PK=x), and asks it to serialize itself as a graph of lightweight objects. In this case, that means, returning the LWEmployeeImpl 702 object for the entity serialized into a byte stream.

The client container de-serializes the byte stream, noting as it does so that LWEmployeeImpl 702 is an instance of LWEntity 704, and of LWEmployee 701. After creating the LWEmployeeImpl 702 object, the container creates a proxy for it that implements both LWEmployee 701 and LWEntity 704. The LWEmployee 701 interface on the proxy object is then exposed by the container, to the client code.

When the client code wants to interact with the employee object, it does so by invoking a method on the LWEmployee 701 interface. This invocation is intercepted by the proxy class, which notes the call being made on an invocation stack, then passes the invocation on to the actual LWEmployeeImpl object 702.

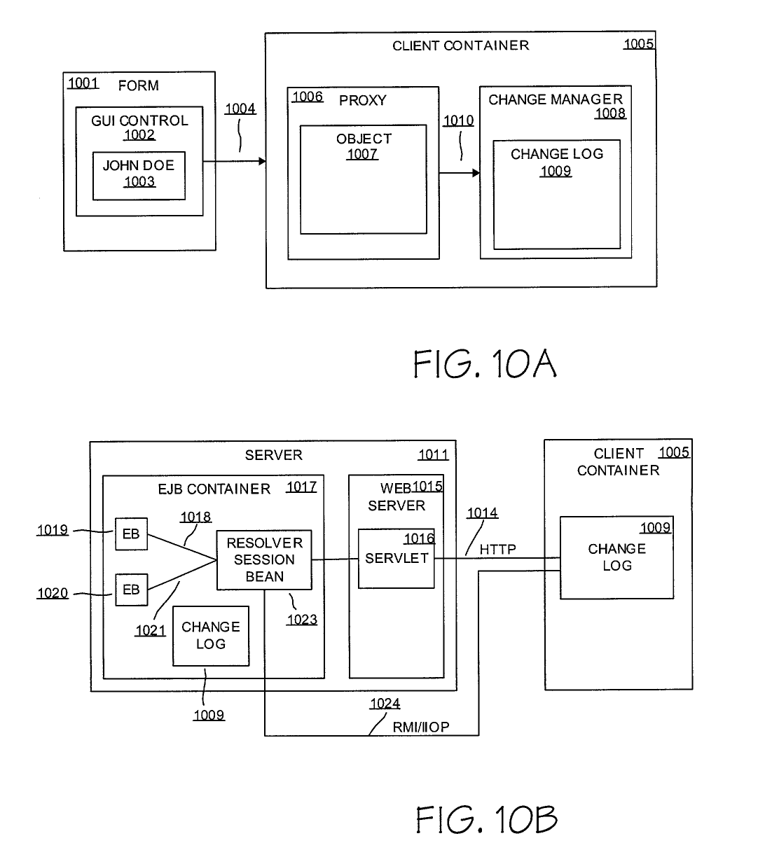

When it is time to “save” the changed employee, the client container sends the invocation stack to the server, where a “Resolver” session bean replays the method invocations, but against the heavyweight “Employee” entity bean. The delta tracking service is further described with reference to FIGS. 10A and 10B.

In a real client container, more that one object would be in most graphs, and the invocation stack has to accommodate object creation, deletion and reassignment, in addition to simple business method invocation. The method requires that certain contracts be observed.

The client code must contract to interact with the lightweight objects only through their published lightweight interfaces. In particular, interactions with dependent objects which are not themselves LWEntity 704 must be through the parent object.

The implementation of behavior in the heavyweight server objects must be compatible with that of the lightweight objects. This is accomplished by having the bean implementations inherit from the lightweight implementations, but this is not necessary.

The remote interface of the entity beans must be a superset of the corresponding lightweight interface. It does not need to extend the lightweight interface, however any method signature in the lightweight interface must be expressed by the heavyweight bean class and appear in the remote interface.

With reference now to FIG. 8, a flowchart showing object statement management, the next service provided by the client container is checkpoints and rollbacks. One goal of a rich GUI application is to give users flexibility in their navigation and workflow. One element of this is often permitting users to make tentative changes, or undo changes without unacceptable results. Putting business behavior on the client, inside the container, permits the user to see the result of a change, but some method is needed to facilitate undoing changes.

The invocation stack described in the previous discussion of delta tracking, function shipping and dynamic proxies lends itself to this in a natural fashion. By marking the stack with “checkpoints” and permitting the client code to request a “rollback” to the previous checkpoint, a progressive undo can be created.

In order to make this work, the checkpoint functionality has to do two things. First, mark the invocation stack, so that on an undo request, invocations subsequent to the mark can be peeled off the stack. Second, save the state of all objects in the container as of the checkpoint. This latter is facilitated by the proxy objects that mediate client interaction with the objects inside the client container. When a checkpoint is established, the proxy objects can be instructed to clone their lightweight implementations whenever a change is requested, and to maintain a handle to the pre-checkpoint state. If a rollback to the checkpoint occurs, the pre-checkpoint version is re-instated as the object of the proxy.

The client container can take a snapshot of an object graph 800 that records object X having a state of 0. The conditions under which snapshots are taken are directed by a programmer developing an application using the client container framework. A user may change the state of an object 801, in this case changing the state of object X to 1. At some point the application gives a user an opportunity to save a particular set of changes, all of which would be tracked by snapshots 802. If the user chooses to accept the change in the state of the object, the snapshot is freed and the new state is preserved 803. If the user chooses to reject the change in the state of the object, the snapshot is restored and the object is returned to the state at the time of the snapshot 804. These snapshots can be nested, so that the successive changes in an object graph can be tracked as a user modified the data set, and the data can be rolled back to any point and returned to the server in an appropriately modified state.

With reference now to FIG. 9, a sequence diagram depicting how elements of the client container interact, the final service provided by the client container is described: the implementation of container aware controls using the Swing Java Foundation Classes (Swing). In a Java GUI application that uses the Swing user interface components, coupling of the components to domain objects can be a substantial fraction of the development effort. The client container approach presents an opportunity to significantly shorten this effort.

The Swing model-view-controller architecture was described in the text describing FIG. 5. The client container implements a model source pattern in order to eliminate the need for most custom model implementations. It contains and controls access to the domain object model, and can present it in whatever format (model interface) required for a component.

Form 900 is a graphical user interface window created by the developer containing container-aware Swing user interface components. A form can contain other standard Swing components such as panels or buttons for layout and navigation purposes. When the Form 900 is created 905 by the client application, it creates instances of the container-aware, GUI components 906 as part of standard form creation in Java. Container Aware GUT Component 901 represents any container-aware, Swing control descendent. It can be any of the provided container-aware controls such as a textbox or listbox, or a subclass of one of these. When the control is created 907, it creates its custom, Container-Aware Model 902 automatically, again in standard Swing practice.

Container Aware Model 902 represents a container-aware, Swing descendent model for the appropriate control. When instantiated, Container Aware Model 902 registers 908 with the control's ModelSource 903 to receive graph population events. ModelSource 903 is a provider of object graphs, retrieving and updating data from the LightweightObject(s) 904 in the client container as requested by the GUI Components 901. Typically, the provider of graphs is the client container itself, but other components may also serve as a ModelSource 903. This allows, for example, controls to be linked to the current selection in a container-aware listbox. When a ModelSource 903 has graph data (whether because of a registration of a graph or the selection of an item in a collection control), the ModelSource 903 alerts each listener on the graph that data exists (steps 909-914). Container-Aware Model 902 knows what field in the object graph it is bound to through properties on its associated control. The model can then reflectively call the appropriate method to interact with the object property.

Swing GUI Components 901 are sub-classed to be container-aware. The component knows how to request a model implementation for a specific cross section of data from the client container. For example, in the domain example described earlier, a JTextArea Swing descendant control might request a Document descendant implementation that represents the Name field of the Employee object. A JTable descendent might request a TableModel descendent for all the OptionalWithholdings for an Employee, specifying what fields in an OptionalWithholding object map to what columns in the table. In addition to the object and fields, each component specifies a named graph from which the objects are to be drawn.

The client container performs its function by acting as an instance of a ModelSource 903 interface. The GUI Components 901 know only about this interface, not about the client container directly. The Container Aware Model 902 interacts with the DomainObject 904 to apply changes made by users through the Components 901 and update the Components 901 with changes made externally to the DomainObject 904 under the Swing framework.

As shown in FIGS. 10A and 10B, to perform delta tracking in the client application, a Method Call 1004 is made on a Proxy 1006 of a Lightweight Object 1007. This happens either when a user makes a change in a container aware GUI Component 1002, or programmatically. For example, to change the name property of a customer domain object, the client application might programmatically call “setName” on the Customer Object 1007 (which is proxied), or this might be done intrinsically by entering a name in a textbox that is bound to the name property of a customer object.

The Proxy 1006 intercepts the Method Call 1004 and first performs miscellaneous internal activities. Next, the Proxy 1006 then calls the identical method of the Lightweight Object 1007. Again, using the customer example from above, the “setName” Method Call 1004 is first called on the Proxy 1006, which in turn reflectively calls the “setName” Method 1004 of the Lightweight Object 1007. The lightweight object Method 1004 executes and eventually program control returns to the Proxy 1006. At this point, the Proxy 1006 determines if the Lightweight Object 1007 changed as a result of the Object Call 1004. If a change occurred, the Proxy 1006 notifies the Client Container 1005 of this event, and the Client Container 1005 appends the event to a Change Log 1009.

As shown in FIG. 10B, when the client application wishes to save the changes being accumulated by the Client Container 1005 back to the server, the client container serializes the Change Log 1009 and sends the information to a supplied Session Bean 1023 residing on the EJB server 1011. This information may be sent directly to the session bean over RMI/IIOP, or indirectly routed over HTTP to a supplied Servlet 1016 residing on a Web Server 1015.

The Resolver Session Bean 1023 deserializes the Change Log 1009, and begins looking up the Entity Beans 1019 and 1020 corresponding to the Lightweight Objects 1007 that were modified on the client, and calls the identical Method 1004 on the Entity Bean 1019 or 1020 that resulted in the Object 1007 being modified in order as it happened on the client.

FIG. 11 shows the process flow of transforming a graph of Entity Beans (“heavyweight objects”) 1104 into a Lightweight Object Graph 1107, and returning them to a Client Application 1101.

First, the Client Application 1101 initiates a Request 1103 to retrieve a Graph of Lightweight Objects 1106. The Request 1103 is a method call of a framework-supplied interface that all framework-aware Entity Beans 1104 implement. The Request 1103 includes a Graph Descriptor 1102, whose primary purpose is defining the depth of the graph to be traversed, transformed and returned to the client. For example, a customer object could lead to an immensely large graph if even a dozen levels of the graph were traversed. The Graph Descriptor 1102 defines the subset of the graph to be returned to the Client Application 1101 for its current task.

The Root Entity Bean 1104 implements the method of the Request 1103 by delegating to a framework supplied Object Provider 1105. This Provider 1105 is specifically a static class method. The Provider 1105 first calls another framework interface method to obtain a Lightweight Object 1106 from the heavyweight Entity Bean 1104. Because an Entity Bean 1104 inherits from a Lightweight Object 1106 class, the Lightweight Object 1106 contains only the methods, fields, and functionality defined in the lightweight class.

The Object Provider 1105 repeats this process recursively on the Entity Bean 1104 graph, constructing a Graph of Lightweight Objects 1107 that mirrors the Heavyweight Objects 1104 for the depth specified by the Graph Descriptor 1102.

Upon completion of the Lightweight Object Graph 1107, the root Entity Bean 1104 returns the Lightweight Object Graph 1107 to the Client Application 1101 as a Result 1108 to the Client Application 1101.

Although the present invention has been described with reference to preferred embodiments, persons skilled in the art will recognize that changes may be made in form and detail without departing from the spirit and scope of the invention.

We claim:

1. A computer-implemented method for executing a Java application on a client using data hosted on an EJB server, the method comprising:
generating an object graph descriptor;
creating a light-weight object graph, based on the object graph descriptor, the light-weight object graph being a subset of a domain object graph on the EJB server;
transporting the light-weight object graph to the client;
executing the Java application on the client;
monitoring a plurality of method invocations performed on the client that interact with the light-weight object graph;
logging a subset of method invocations of the plurality of method invocations that result in a change to the light-weight object graph in a stack; and
persisting changes to the domain object graph on the EJB server.

2. The method of claim 1 wherein transporting of the light-weight object graph includes serializing the light-weight object graph on the EJB server into a byte-stream, communicating the byte-stream to the client, and deserializing the byte-stream on the client.

3. The method of claim 1 wherein the object graph descriptor identifies at least one root object and at least one degree of traversal from the root object.

4. The method of claim 1 wherein the Java application is a Java graphical user interface application.

5. The method of claim 1 wherein the monitoring step is performed using a dynamic proxy.

6. The method of claim 5 wherein the monitoring step includes the dynamic proxy receiving a method call, the proxy executing the method call on an object in the light-weight object graph, and the proxy determining if the object changed as a result of the method call.

7. The method of claim 1 wherein persisting the changes to the domain object graph on the EJB server includes communicating the stack to the EJB server and executing the method calls thereon.

8. The method of claim 1 further including placing at least one flag in the stack and generating a corresponding snapshot of the light-weight object graph, prior to operation of the method invocation immediately following the flag, such that a user could cause the state of each of a plurality of objects in the light-weight object graph to return to a previous state.

9. The method of claim 1 wherein executing a Java application on the client includes generating a container aware model adapted to allow the Java application to retrieve data from the light-weight objects embedded in the light-weight object graph.

10. The method of claim 9 wherein executing a Java application on the client includes creating a form in communication with the light-weight object graph through the container aware model.

11. The method of claim 10 wherein the container aware model is created by extending a standard Java Swing model.

12. The method of claim 3 wherein creating a light-weight object graph includes:
locating the root entity bean specified by the at least one root object in the domain object graph;
locating at least one related entity bean in the domain object graph, as specified by the degree of traversal; and
returning a first implementation of the light-weight class from which the root entity bean inherits and a second implementation of the light-weight class from which the related entity bean inherits.

13. The method of claim 12 wherein the first implementation and the second implementation are generated by an object provider.

14. The method of claim 1 further including extending the light-weight object graph, based on an extension request from the client identifying an extension root and an extension degree of traversal, creating a light-weight version of the corresponding objects, and transporting the corresponding objects to the client.

15. The method of claim 1 wherein the domain object graph on the EJB server includes a collection of heavy-weight entity beans and the entity beans are created from:
a foundational light-weight object class specifying a set of states and a set of behaviors associated with a set of light-weight objects;
at least one specific light-weight object class specifying a second set of states and set of behaviors associated with the specific light-weight object class, the specific light-weight object class inheriting from the foundational light-weight object class; and
at least one instance of the at least one specific light-weight object class, the at least one instance including information corresponding to the first and second set of states.

16. The method of claim 4 wherein the Java graphical user interface application is a Java Swing application.

17. The method of claim 16 wherein the Java Swing application is a container-aware Java Swing application.

18. A computer program product residing on a computer-readable medium for use in creating a client container for interacting with an EJB server, the computer program product comprising:
first instructions for creating a light-weight object graph, based on an object graph descriptor, the light-weight object graph being a subset of a domain object graph on the EJB server;
second instructions for transporting the light-weight object graph to the client;
third instructions for monitoring a plurality of method calls performed on the client that interact with the light-weight object graph;
fourth instructions for logging in a stack a subset of method calls of the plurality of method calls that result in a change to the light-weight object graph; and
fifth instructions for persisting changes to the domain object graph on the EJB server.

19. The method of claim 18 wherein the second instructions include instructions for serializing the light-weight object graph on the EJB server into a byte-stream, communicating the byte-stream to the client, and deserializing the byte-stream on the client.

20. The method of claim 18 wherein the object graph descriptor identifies at least one root object and at least one degree of traversal from the root object.

21. The method of claim 20 wherein the first instructions include instructions for:
locating the root entity bean specified by the at least one root object in the domain object graph;
locating at least one related entity bean in the domain object graph, as specified by the degree of traversal; and
returning a first implementation of the light-weight class from which the root entity bean inherits and a second implementation of the light-weight class from which the related entity bean inherits.

22. The method of claim 18 including sixth instructions for placing at least one flag in the stack and generating a corresponding snapshot of the light-weight object graph, prior to operation of the method invocation immediately following the flag, such that a user could cause the state of each of a plurality of objects in the light-weight object graph to return to a previous state.

23. The method of claim 18 wherein persisting the changes to the domain object graph on the EJB server includes communicating the stack to the EJB server and executing the method calls thereon.

24. The method of claim 23 wherein the fifth instruction include instruction for creating a session bean responsible for executing the method calls in the stack on the EJB server.

25. The method of claim 18 further including sixth instructions for extending the light-weight object graph, based on an extension request from the client identifying an extension root and an extension degree of traversal, creating a light-weight version of the corresponding objects, and transporting the corresponding objects to the client.

26. The method of claim 18 further including sixth instructions for defining a set of container-aware Java graphical user interface applications.

27. The method of claim 26 further including instructions for defining a container-aware model, as an extension of a standard Java Swing model, the container-aware model adapted to allow the Java application to retrieve data from a plurality of light-weight objects embedded in the light-weight object graph.

28. The method of claim 18 wherein the third instructions include instructions for using a dynamic proxy to receive a method call, execute the method call on an object in the light-weight object graph, and determine if the object changed as a result of the method call.

29. The method of claim 18 wherein the domain object graph on the EJB server includes a collection of heavy-weight entity beans and the entity beans are created from:
a foundational light-weight object class specifying a set of states and a set of behaviors associated with a set of light-weight objects;
at least one specific light-weight object class specifying a second set of states and set of behaviors associated with the specific light-weight object class, the specific light-weight object class inheriting from the foundational light-weight object class; and
at least one instance of the at least one specific light-weight object class, the at least one instance including information corresponding to the first and second set of states.

30. A computer system for executing a Java application on a client using data hosted on an EJB server, the system comprising:
a first storage medium located on the EJB server, the first storage medium including a domain object graph consisting of a plurality of heavy-weight objects;
a servlet located on the EJB server, the servlet configured to execute computer code adapted to:
(i)create a light-weight object graph, based on an object graph descriptor, the light-weight object graph being a subset of the domain object graph; and
(ii)transport the light-weight object graph to the client;
a processor located on the client; and
a second storage medium located on the client, the second storage medium storing the light-weight object graph and computer code adapted to:
(i)execute the Java application; and
(ii)log a subset of method calls of the plurality of method calls that result in a change to the light-weight object graph;

31. The method of claim 30 wherein the client computer code is further adapted to return the subset of method calls to the EJB server, and the servlet is further adapted to update the domain object graph, based on any change functions at the client that affected a state of a light-weight object within the light-weight object graph.

32. The method of claim 30 wherein the object graph descriptor identifies at least one root object and at least one degree of traversal from the root object.

33. The method of claim 30 wherein the instructions for creating a lightweight object graph include instructions for:
locating the root entity bean specified by the at least one root object in the domain object graph;
locating at least one related entity bean in the domain object graph, as specified by the degree of traversal; and
returning a first implementation of the light-weight class from which the root entity bean inherits and a second implementation of the light-weight class from which the related entity bean inherits.

34. The method of claim 30 wherein transporting of the light-weight object graph includes serializing the light-weight object graph on the EJB server into a byte-stream, communicating the byte-stream to the client, and deserializing the byte-stream on the client.

35. The method of claim 30 wherein the Java application is a Java graphical user interface application.

36. The method of claim 30 wherein the code adapted to log a subset of method calls includes code for using a dynamic proxy.

37. The method of claim 36 wherein the code adapted to log a subset of method calls includes code for using the dynamic proxy for receiving a method call, executing the method call on an object in the light-weight object graph, and determining if the object changed as a result of the method call.

38. The method of claim 30 wherein executing a Java application on the client includes generating a container aware model adapted to allow the Java application to retrieve data from the light-weight objects embedded in the light-weight object graph.

39. The method of claim 38 wherein executing a Java application on the client includes creating a form in communication with the light-weight object graph through the container aware model.

40. The method of claim 30 wherein the domain object graph on the EJB server includes a collection of heavy-weight entity beans and the entity beans are created from:
a foundational light-weight object class specifying a set of states and a set of behaviors associated with a set of light-weight objects;
at least one specific light-weight object class specifying a second set of states and set of behaviors associated with the specific light-weight object class, the specific light-weight object class inheriting from the foundational light-weight object class; and
at least one instance of the at least one specific light-weight object class, the at least one instance including information corresponding to the first and second set of states.

41. A computer-implemented method for executing an application on a client using a domain object graph hosted on an EJB server, the method comprising:
generating an object graph descriptor identifying at least one root object and at least one degree of traversal from the root object;
creating a light-weight object graph, based on the object graph descriptor, the light-weight object graph being a subset of the domain object graph on the EJB server; and
transporting the light-weight object graph to the client.

42. The method of claim 41 wherein transporting the light-weight object graph includes serializing the light-weight object graph on the EJB server into a byte-stream, communicating the byte-stream to the client, and deserializing the byte-stream on the client.

43. The method of claim 41 wherein creating a light-weight object graph includes:
locating the root entity bean specified by the at least one root object in the domain object graph;
locating at least one related entity bean in the domain object graph, as specified by the degree of traversal; and
returning a first implementation of the light-weight class from which the root entity bean inherits and a second implementation of the light-weight class from which the related entity bean inherits.

44. The method of claim 43 wherein the first implementation and the second implementation are generated by an object provider.

45. The method of claim 40 further including extending the light-weight object graph, based on an extension request from the client identifying an extension root and an extension degree of traversal, creating a light-weight version of the corresponding objects, and transporting the corresponding objects to the client.

46. The method of claim 40 wherein the domain object graph on the EJB server includes a collection of heavy-weight entity beans and the entity beans are created from:
a foundational light-weight object class specifying a set of states and a set of behaviors associated with a set of light-weight objects;
at least one specific light-weight object class specifying a second set of states and set of behaviors associated with the specific light-weight object class, the specific light-weight object class inheriting from the foundational light-weight object class; and
at least one instance of the at least one specific light-weight object class, the at least one instance including information corresponding to the first and second set of states.

47. A computer-implemented, object-oriented programming model for facilitating execution of an application on a client using data stored on an EJB server, the model including:
a foundational light-weight object class specifying a set of states and a set of behaviors associated with a set of light-weight objects;
at least one specific light-weight object class specifying a second set of states and set of behaviors associated with the specific light-weight object class, the specific light-weight object class inheriting from the foundational light-weight object class;
at least one instance of the at least one specific light-weight object class, the at least one instance including information corresponding to the first and second set of states; and
at least one entity bean including a third set of behaviors, the entity bean inheriting from the at least one instance.

48. A method of resolving changes between a light-weight object graph located on a client and a domain object graph located on an EJB server, the method comprising:
monitoring a plurality of method invocations performed on the client that interact with the light-weight object graph;
logging a subset of method invocations of the plurality of method invocations that result in a change to the light-weight object graph in a stack;
transporting the stack to the EJB server; and
executing the method calls on the domain object graph.

49. The method of claim 48 wherein transporting of the stack includes serializing the plurality of method invocations into a byte-stream, communicating the byte-stream to the EJB server, and deserializing the byte-stream on the EJB server.

50. The method of claim 48 wherein the method invocations are executed on the EJB server using a session bean.

51. The method of claim 48 wherein the monitoring step is performed using a dynamic proxy.

52. The method of claim 48 wherein the monitoring step includes the dynamic proxy receiving a method invocation, the proxy executing the method invocation on an object in the light-weight object graph, and the proxy determining if the object changed as a result of the method invocation.
